(19) United States
(12) Patent Application Publication
(10) Pub. No.: US 2003/0168469 A1
(43) Pub. Date: Sep. 11, 2003

(54) Apparatus for dispensing heated comestibles

(76) Inventors: Mark Nathan Beagle, Durban (ZA); Gordon Peter Ramsay, Durban (ZA)

Correspondence Address: YOUNG & THOMPSON, 745 SOUTH 23RD STREET 2ND FLOOR, ARLINGTON, VA, 22202

(21) Appl. No.: 10/344,574

(22) PCT Filed: Aug. 16, 2001
(86) PCT No.: PCT/ZA01/00118

(51) Int. Cl. B65H 1/00; G07F 11/00; A24F 27/14

(52) U.S. Cl. 221/119; 221/150 A

(57) ABSTRACT

Apparatus for automatic heating of comestibles such as popcorn comprises a magazine with compartments for housing the comestibles, for example in packets, means to rotate the magazine for presentation of a chosen compartment to the rear of the microwave oven, means to urge the lowermost packet or comestible through a flap of the oven, automatic heating of the oven for a predetermined time and temperature, after which the bottom of the oven is hinged open for the comestible or packet to fall out.

### TECHNICAL FIELD OF THE INVENTION

This invention relates to apparatus for dispensing comestibles such as pop corn, pies, sausage rolls, pizzas and many others.

### BACKGROUND ART

Popcorn is conventionally made in a heated container which is usually transparent so that the operator can observe the heating or popping process. Pop corn is removed from the container by a scoop into a packet. If a variety of flavours are required, it will be necessary to provide a corresponding number of containers.

It is necessary for the operator or operators to be reasonably skilled.

It is an object of the present invention to provide a self service apparatus and thereby avoid the necessity for a skilled operator. A further object of the invention is to provide a number of different flavours or other attributes of a comestible/s so that the purchaser may make a choice.

A yet further object of the invention is the provision of an unattended apparatus.

These and other objects and advantages of the invention will become apparent as this specification proceeds.

### DISCLOSURE OF THE INVENTION

According to the invention apparatus for dispensing heated comestibles includes a magazine adapted to be moved into any of a number of positions in relation to a heating station, the magazine being adapted to store comestibles and to present them to the heating station, means to urge the comestibles into the heating station, means to heat the transferred comestible/s at a predetermined temperature and time, and means to recover the heated comestible.

In a preferred form of the invention the apparatus also includes a coin-operated arrangement for at least one of the succession of actions.

The heating station is preferably a microwave oven with access for the comestible/s from the magazine. The customer should not have access to the magazine.

The magazine is preferably vertical and rotatable about the vertical. It may contain a plurality of compartments for packets of the comestible/s, preferably more than four arranged radially n the magazine.

The transfer of a packet from the magazine to the oven is preferably achieved by means of a plunger which is operated by mechanical means or by a pneumatic slave cylinder, the plunger urging the bottom most packet from the chosen compartment to enter the oven. A flap may be provided at the rear of the oven to open to receive the packet and then close.

The oven is then activated to heat the packet at a predetermined temperature and the floor of the oven may be hinged and the packet, when heated, may fall on to a platform or the like by virtue of the tipped bottom. This tipping action may also be achieved mechanically or by the same pneumatic slave cylinder.

### BRIEF DESCRIPTION OF THE DRAWINGS

An embodiment of the invention is described below with reference to the accompanying drawings in which:

FIG. 1 is an isometric view of apparatus according to the invention with certain walls omitted for illustrative purposes;

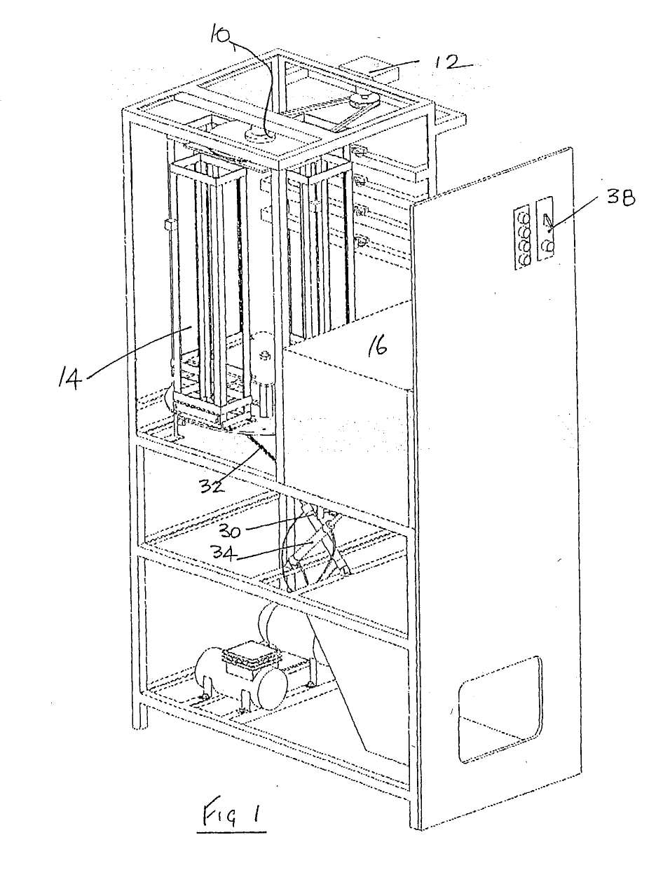

FIG. 2 is a similar view showing the compartments filled with packets of comestibles, such as corn;

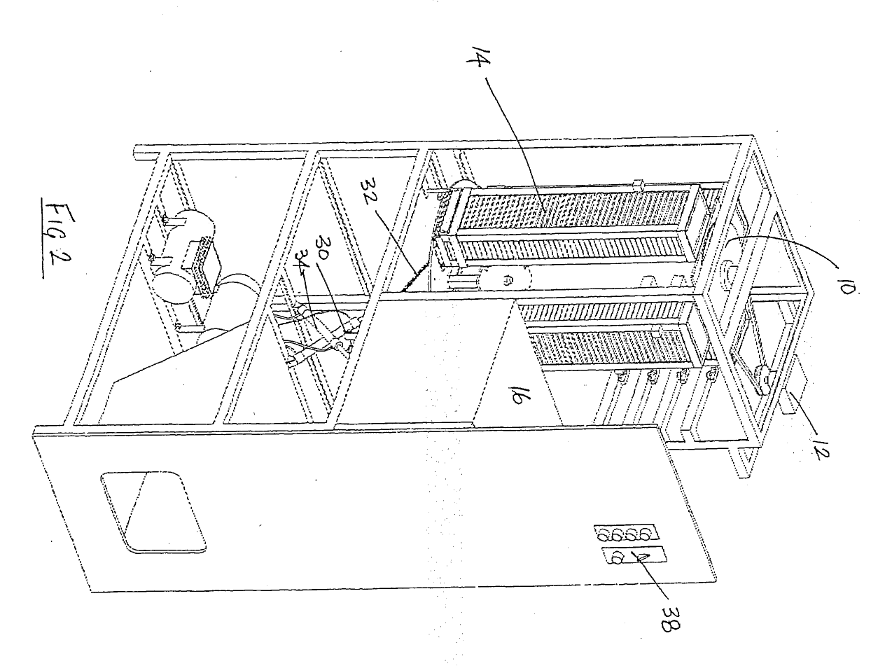

FIG. 3 is a detailed view of the top zone of the apparatus illustrating the rotation of the magazine;

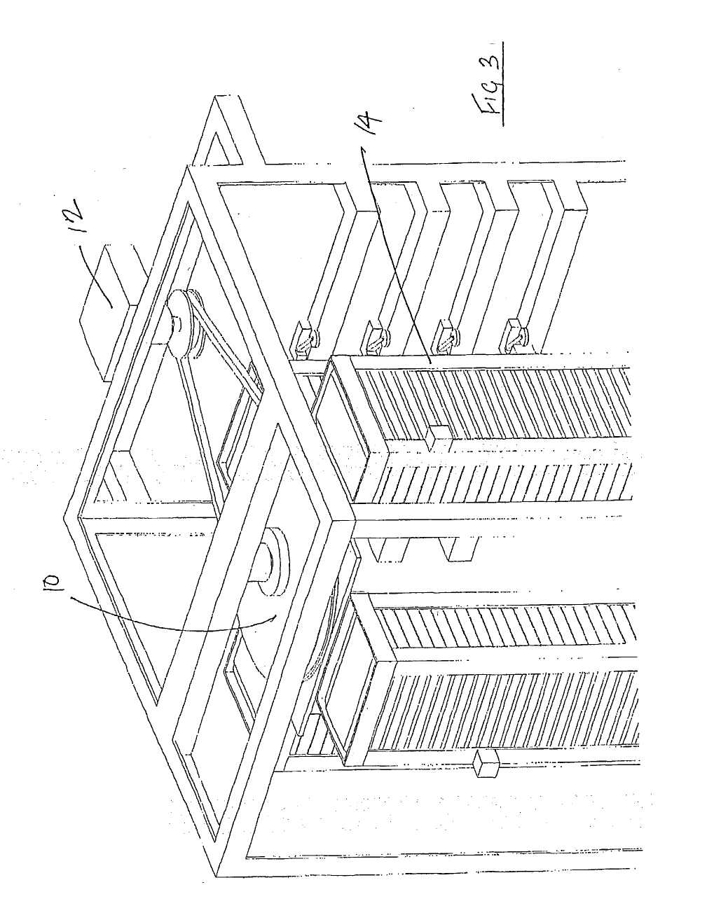

FIG. 4 is a isometric detailed view of the mechanisms for the plunger and oven floor opening;

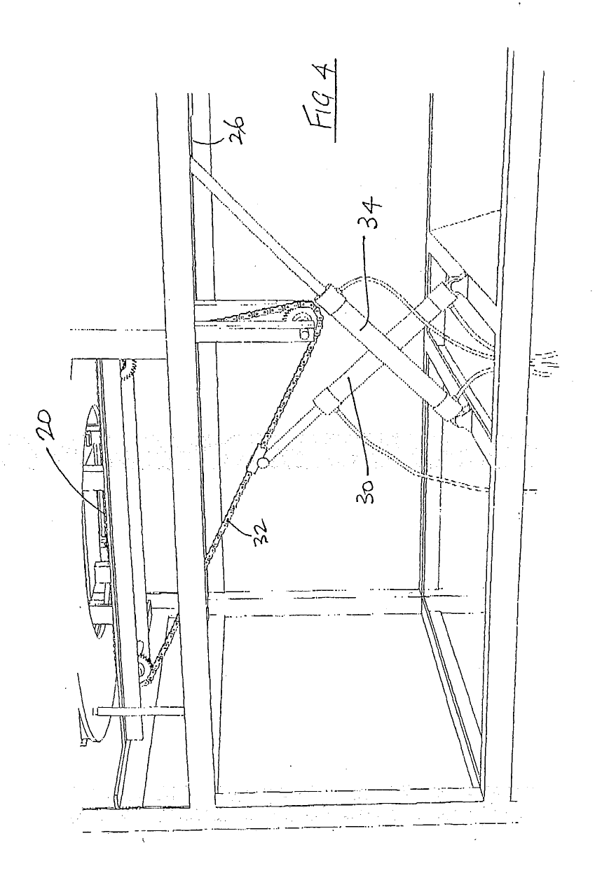

FIG. 5 is an similar view to FIG. 4 but from a slightly different angle;

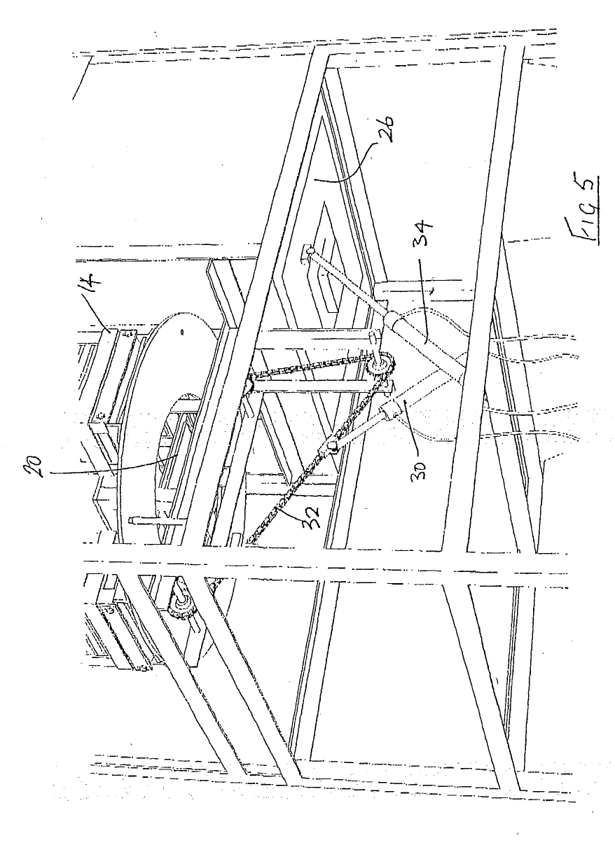

FIG. 6 is a side view of the lower zone of the apparatus in its first position;

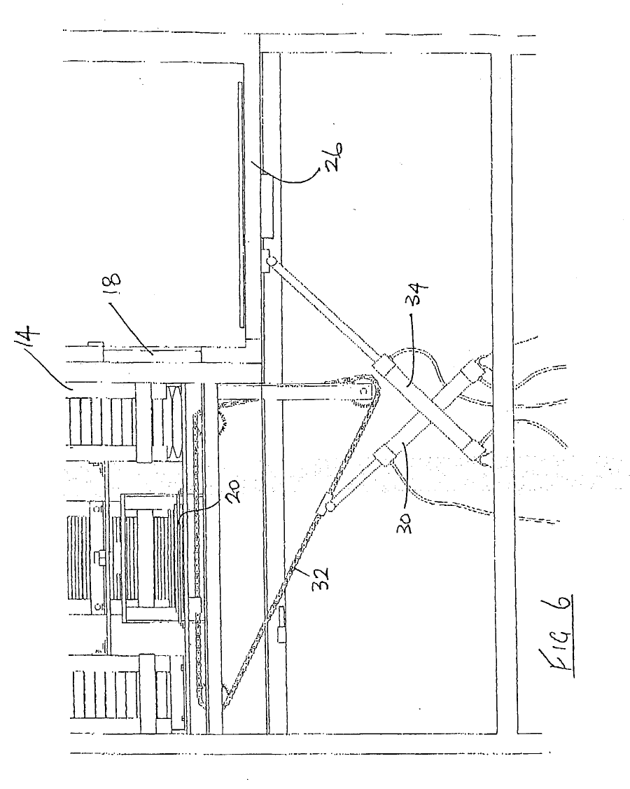

FIG. 7 is a similar view with the apparatus in its second position; and

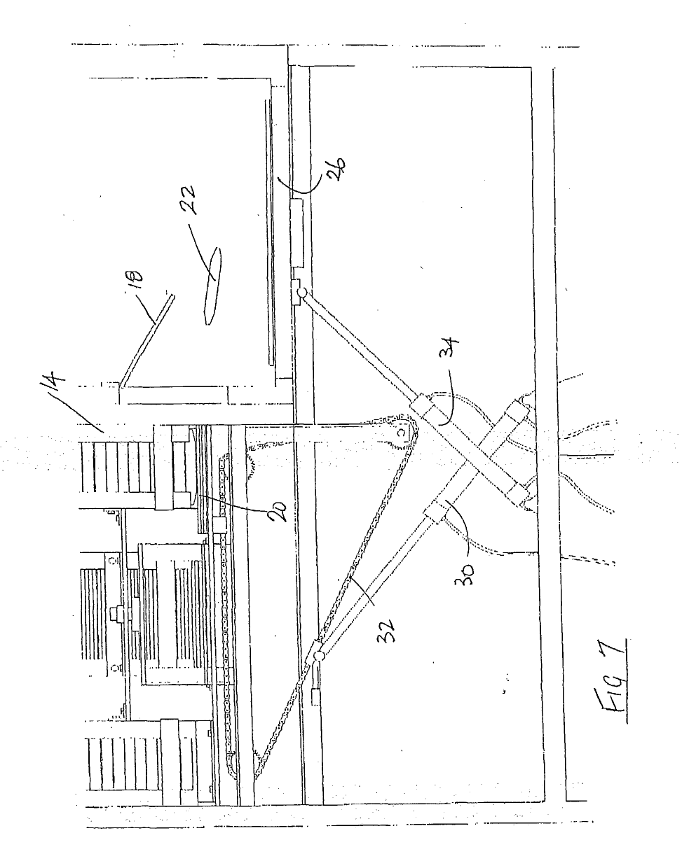

FIG. 8 is a similar view with the apparatus in its third position.

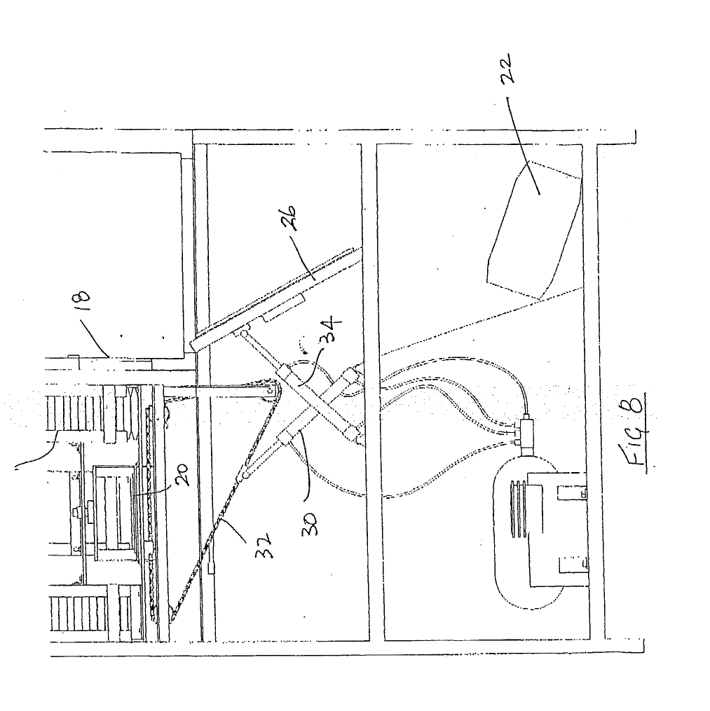

### BEST MODE FOR CARRYING OUT THE INVENTION

In the drawings, a magazine 10 is mounted for rotation about a vertical centre by means of a motor 12. The magazine has four compartments 14 which accommodate packets of comestible/s.

The magazine is rotated until the chosen compartment is located at the rear of a microwave oven 16. This corresponds with the first position of the apparatus. The oven has a rear flap 18 which opens when a plunger 20 urges the bottom packet 22 of the compartment therethrough whence it falls on to the hinged floor 26 of the oven. This corresponds with the second position of the apparatus The plunger is actuated by pneumatic slave cylinder 30 through a chain 32. A second slave cylinder 34 controls the opening and closing of the hinged floor 36 of the oven

Once a packet is in position, the rear flap closes and the oven circuit switches on for a predetermined time at a predetermined temperature. The floor 26 then opens, corresponding with the third position of the apparatus and dropping the heated packet for retrieval by the customer.

A coin operated mechanism 38 is provided to control the operation of the sequence of events and this conveniently begins after the choice of compartment by the customer. The latter then inserts a coin and presses a button which starts the sequence.

1. Apparatus for dispensing heated comestibles characterised in that it includes a magazine adapted to be moved into any of a number of positions in relation to a heating station, the magazine being adapted to store comestibles and to present them to the heating station, means to urge the comestibles into the heating station, means to heat the transferred comestible/s at a predetermined temperature and time, and means to recover the heated comestible.

2. The apparatus according to claim 1 characterised in that it includes a coin-operated arrangement for at least one of the succession of actions.

3. The apparatus according to either of the above claims characterised in that the heating station is a microwave oven with access for the comestible/s from the magazine.

4. The apparatus according to any of the above claims characterised in that the magazine is vertical and rotatable about the vertical.

5. The apparatus according to any of the above claims characterised in that the magazine contains a plurality of compartments for packets of comestible/s.

6. The apparatus according to any of the above claims characterised in that the transfer of a packet from the magazine to the oven is achieved by means of a plunger which is operated by mechanical means or by a pneumatic slave cylinder, the plunger urging the bottom most packet from the chosen compartment to enter the oven.

7. The apparatus according to claim 6 characterised in that a flap is provided at the rear of the oven to open to receive the packet and then close.

8. The apparatus according to claim 7 characterised in that the oven is then activated to heat the packet at a predetermined temperature and the floor of the oven is hinged from the packet, when heated to fall on to a platform or the like.

9. The apparatus according to claim 8 characterised in that the floor of the oven opens and closes by means of a pneumatic slave cylinder.
